(19) United States
(12) Patent Application Publication
(10) Pub. No.: US 2021/0319143 A1
(43) Pub. Date: Oct. 14, 2021

(54) MEMORY BUS LINK AUTHENTICATION AND ENCRYPTION MECHANISMS FOR HARDWARE-BASED REPLAY PROTECTION

(71) Applicant: Intel Corporation, Santa Clara, CA (US)

(72) Inventors: Siddhartha Chhabra, Portland, OR (US); David M. Durham, Beaverton, OR (US)

(73) Assignee: Intel Corporation, Santa Clara, CA (US)

(21) Appl. No.: 17/358,677

(22) Filed: Jun. 25, 2021

(51) Int. Cl. G06F 21/79; G06F 21/60; G06F 21/57; H04L 9/08; H04L 9/32

(52) U.S. Cl. CPC G06F 21/79; G06F 21/602; H04L 9/3242; H04L 9/0841; H04L 9/0819; G06F 21/575

(57) ABSTRACT

In one embodiment, a system includes a processor and a memory module coupled to the processor over a memory bus. The processor and memory module perform a key exchange at boot to obtain an encryption key. The processor generates first ciphertext by encrypting plaintext data using a first encryption protocol, and generates second ciphertext by encrypting the first ciphertext using a second encryption protocol based on the encryption key obtained at boot. The second ciphertext is transmitted to the memory module via the memory bus. The memory module decrypts the second ciphertext based on the encryption key obtained at boot to yield third ciphertext, and stores the third ciphertext.

### TECHNICAL FIELD

This disclosure relates in general to the field of computer systems and, more particularly, to memory bus link authentication and encryption mechanisms to provide hardware-based replay protection.

### BACKGROUND

Current memory protection technologies tend to center around confidentiality and integrity (i.e., tamper) protection of data on the memory data bus via hardware-based cryptographic methods, leaving the system vulnerable to other attacks, such as hardware replay of stale data and access pattern monitoring.

### BRIEF DESCRIPTION OF THE DRAWINGS

FIG. 1 illustrates an example system that implements memory bus link encryption techniques in accordance with embodiments of the present disclosure.

FIG. 2 illustrates an example DIMM logic unit (DLU) in accordance with embodiments of the present disclosure.

FIGS. 3A-3B illustrate an example encryption/decryption scheme that may be used to implement memory bus encryption in accordance with embodiments of the present disclosure.

FIG. 4 illustrates example layers of encryption that may be in place in the example system of FIG. 1.

FIG. 5 illustrates a flow diagram of an example process of encrypting data over a memory bus in accordance with embodiments of the present disclosure.

FIGS. 6A-6B illustrate example processes that may be implemented by components of an SoC to provide memory bus encryption in accordance with embodiments of the present disclosure.

FIGS. 7A-7B illustrate example processes that may be implemented by components of a memory module to provide memory bus encryption in accordance with embodiments of the present disclosure.

FIG. 8 is an example illustration of a processor according to an embodiment.

FIG. 9 illustrates a computing system that is arranged in a point-to-point (PtP) configuration according to an embodiment.

Like reference numbers and designations in the various drawings indicate like elements.

### DETAILED DESCRIPTION OF EXAMPLE EMBODIMENTS

In the following description, numerous specific details are set forth, such as examples of specific configurations, structures, architectural details, etc. in order to provide a thorough understanding of the present disclosure. It will be apparent, however, to one skilled in the art that these specific details need not be employed to practice embodiments of the present disclosure. In some instances, well known components or methods may be utilized, and such details haven't been described in detail in order to avoid unnecessarily obscuring embodiments of the present disclosure.

Current memory protection technologies tend to center around confidentiality and integrity (i.e., tamper) protection of data on the memory data bus via hardware-based cryptographic methods, leaving the system vulnerable to other attacks, such as hardware replay of stale data and access pattern monitoring.

As one example, an attacker can flip a bit on the address bus to effectively result in a write getting dropped (written to a different location than intended). Such attacks can subvert the security of secure ranges such as PRMRR and SEAMRR for SGX and TDX respectively by allowing the hardware attacker to do a successful replay attack (i.e., replaying stale version of a cache-line which was dropped/written out to a different region outside SGX/TDX secure ranges). Using these simple address bit flip techniques, the attacker can mis-direct security critical data (potentially deterministically to allocated system address of interest) and also know when to replay stale data back.

To defend against these attacks, one current solution includes a replay protection tree built on memory. However, such solutions incur large performance costs, since with each read and write access, the replay tree needs to be verified and updated to ensure that the data being read from memory is what the processor wrote previously. For instance, to verify a cacheline read from memory, the tree needs to be walked from the cacheline to the root node which is stored on-die and considered secure against hardware attacks. A replay attack would be detected as an integrity failure at some level in the tree. However, a tree walk requires multiple accesses to memory to fetch tree nodes for each memory access to the protected region.

For preventing access pattern leakage, oblivious RAM has been proposed which does multiple random accesses to memory for each access and relocated a cacheline each time it is accessed to hide the access patterns. However, these solutions can result in significant performance and bandwidth overheads making them impractical for implementation on scale. As an example, state-of-the-art ORAM technology to prevent access pattern leakage results in 5X performance overheads.

Embodiments of the present disclosure provide smart authenticated memory modules (e.g., dual inline memory modules (DIMMs)) that can prevent deterministic hardware replay attacks on the memory bus (including address and data) by encrypting the memory bus with a low-cost encryption mechanism that offers temporal uniqueness to ciphertext. In some embodiments, Advanced Encryption Standard (AES) in counter mode (AES-CTR) may be used to encrypt the data over the memory bus link. The memory bus link encryption may be paired with techniques for encrypting data stored in memory. Intel Multi-Key Total Memory Encryption (MKTME) is one example technology that encrypts (and optionally integrity protects) data stored in memory with a block encryption mechanism, e.g., AES-XTS (Advanced Encryption Standard XEX (Xor-Encrypt-Xor) mode with ciphertext stealing). With embodiments of the present disclosure, modification of data on the memory bus using an interposer, as an example, will result in garbling the underlying ciphertext, thereby defeating deterministic replay/integrity attacks.

For example, at boot, a memory module and a security module (e.g., circuitry of a memory controller on a processor or system-on-chip (SoC)) may authenticate each other and may exchange a key to be used for encrypting the memory bus interface. The memory module may also provide fixed address registers that are used for key exchange messages, avoiding changes to the memory bus interface. These addresses used by for key exchange may be marked as reserved by the BIOS (Basic Input/Output System) in the UEFI (Unified Extensible Firmware Interface) memory map to ensure software does not use them for regular use. A new key may accordingly be exchanged at each boot, causing each boot session to be encrypted using a different key. Accordingly, an interposer-based hardware attack will result in corrupted data, preventing a deterministic attack. For example, if an adversary (e.g., hardware-based adversary) tries to replay old data, the memory bus encryption mechanism will use new counter values to decrypt and recover the data as plaintext. This would corrupt any underlying ciphertext (which may be, e.g., MKTME encrypted) preventing a successful replay attack.

In certain embodiments, integrity may be provided on the data by the SoC side module, allowing for such corruption to be detected as well through a message authentication code (MAC). For instance, if memory integrity is supported using a message authentication code with each data line, such corruption is also detected as a security failure offering further goodness in preventing consumption of bad data.

Embodiments herein may accordingly serve as one way towards resilience against hardware replay attacks in memory, providing efficient solutions for defending against deterministic hardware attacks on the memory bus. For example, certain embodiments may introduce simple hardware into a system (e.g., on a system-on-chip (SoC) and DIMM paired with one another) without requiring any changes to the memory interface (e.g., double data rate (DDR) interface) itself, thereby allowing for certain embodiments to be implemented through the chip and/or memory module vendors. In addition, embodiments of the present disclosure may introduce only minimal performance overheads over a base system without any protection. Further, embodiments herein can be combined with hardened memory modules to make attacks on the memory modules invasive, meaning they cannot be carried out without damaging the memory modules. Moreover, the amount of data transferred in embodiments of the present disclosure is unchanged from previous systems, and hence allows for the embodiments to be implemented without any DDR standard changes.

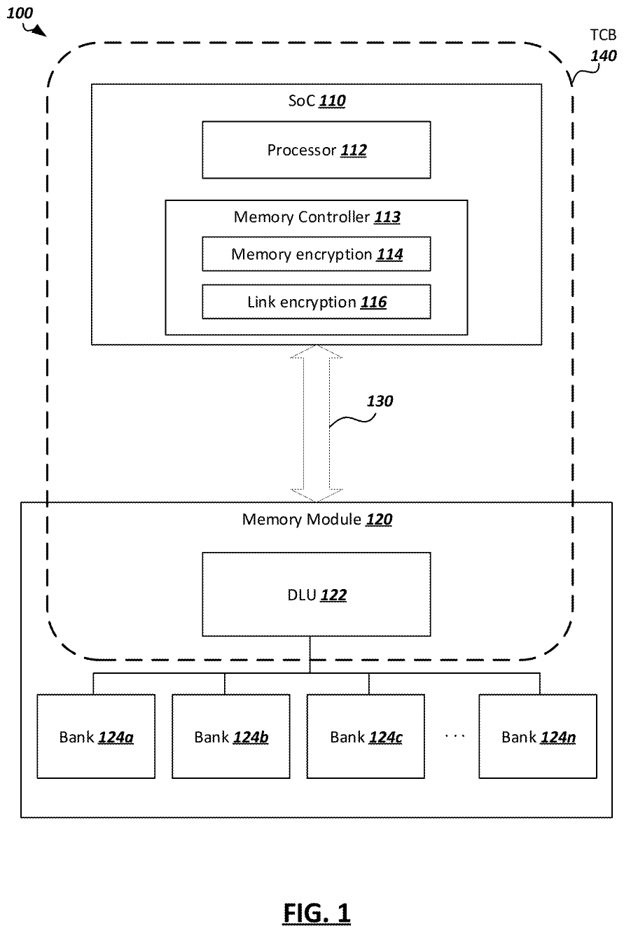

FIG. 1 illustrates an example system 100 that implements memory bus link encryption techniques in accordance with embodiments of the present disclosure. The system 100 includes a system-on-chip (SoC) 110 coupled to a memory module 120 via a memory bus link 130. The memory module 120 may be implemented as a DIMM in certain instances, and the memory bus link 130 may be a DDR-based link. The SoC 110 includes a processor 112, a memory encryption engine 114 and a link encryption engine 116. In some cases, the memory encryption engine 114 and link encryption engine 116 may reside in a memory controller 113 of the SoC 110. The processor 112 may be any type of data processing apparatus that processes input data to generate output data. For example, the processor 112 may include a processor core, a central processing unit (CPU), graphical processing unit (GPU), application processor, field programmable gate array (FPGA), application-specific integrated circuit (ASIC), or any other suitable type of data processor. During operation, the processor 112 may retrieve data from or store data to the memory module 120. The memory controller 113 may manage the flow of data between the processor 112 and the memory module 120, e.g., to provide memory address translation. Although shown as being separate in FIG. 1, the processor 112 and memory controller 113 may be integrated with one another.

The memory encryption engine 114 may encrypt plaintext data sent to the memory module 120 by the processor 112 so that the data is stored as ciphertext in the memory module 120. The memory encryption engine 114 may also decrypt data retrieved from the memory module 120 by the processor 112 to yield plaintext data for processing by the processor 112. In certain embodiments, the memory encryption engine 114 may implement a block encryption mechanism, such as, for example AES-XTS encryption. For instance, certain embodiments may utilize MKTME for the encryption implemented by the memory encryption engine 114. Other types of encryption techniques may be used as well.

The link encryption engine 116 may further encrypt data transmitted over the memory bus link 130 beyond the encryption provided by the memory encryption engine 114. That is, the link encryption engine 116 may provide an additional layer of encryption over the encryption provided by the memory encryption engine 114. For instance, the ciphertext generated by the memory encryption engine 114 (which may be encrypted using, e.g., AES-XTS) may be encrypted by the link encryption engine 116. The link encryption engine 116 may implement a block encryption mechanism, such as, for example, AES-CTR mode. Other types of encryption techniques may be used as well.

The memory module 120 includes a DIMM Logic Unit (DLU) 122 that performs authentication and key exchange with the link encryption engine 116 as well as and link encryption/decryption. The authentication and key exchange may establish authenticity of the memory module 120 and establish a key to be used by the DLU 122 and link encryption engine 116 for link encryption over the memory bus link 130. After authenticity is established between the memory module 120/DLU 122 and the SoC 110/memory controller 113, a trusted compute boundary (TCB) 140 is created.

The DLU 122 may thus receive the double-encrypted data from the SoC 110 over the link 130 and may decrypt the data using the same encryption technique as the link encryption engine 116 (e.g., AES-CTR mode) to yield the same ciphertext that was generated by the memory encryption engine 114. The memory module 120 also includes a number of memory banks 124 that may store data, e.g., the ciphertext generated by the DLU 122 after decryption via the link encryption mechanism (e.g., AES-CTR mode).

As part of the authentication and key exchange, the DLU 122 may be responsible for recognizing some memory addresses as special. These memory addresses may be used for exchanging authentication and key exchange messages solely. The introduction of these special addresses allows embodiments herein to work without requiring any changes to DDR specifications, which may provide for ease in implementation using current standards, allowing for embodiments to be enabled in products in the nearer term.

To cryptographically protect data on the memory bus, the corresponding entities (e.g., the memory controller 113 on SoC 110 and the memory module 120 of FIG. 1) need to share a key (e.g., a 128-bit key or 256-bit key). There can be multiple options to provision these keys, however, two examples are described below.

Key Exchange at Boot

At boot phase, the memory controller (e.g., 113) and the memory module (e.g., 120) would exchange a key based on an authenticated Diffie-Hellman protocol. To achieve this, both entities will have a public-private key pair. In certain embodiments, the private key may be fused in or otherwise incorporated into the product during the component manufacture process (de-layering hardware reverse-engineering attacks out of scope), and a certificate (or certificate chain) holding the public key may be provisioned into the component as well during component validation. For the memory controller, an underlying CPU core-provisioned certificate/private key combinations could be re-purposed for this exchange. Before initiating the key exchange with corresponding memory module, the memory controller may obtain the necessary information from the CPU core via secure side band communication mechanisms.

For the authenticated Diffie-Hellman protocol, the actual key exchange messages may occur using special memory addresses with the memory module 120 (e.g., to avoid changes to DDR specifications). The messages sending public keys, nonce/challenges, acknowledgements, etc. would be performed over the data bus (e.g., link 130 of FIG. 1). The key exchange algorithm steps can be performed in hardware logic or in firmware in microcontrollers inside the two entities (e.g., inside the memory controller 113 and memory module 120 of FIG. 1). If a microcontroller is used, any existing microcontroller inside these modules for control path operations (like refresh control in memory chips) can be re-purposed for key exchange as well. The signed certificate (or certificate chain) can be used for mutual authentication and attestation based on the trustworthiness of the chain that has signed it. At the end of the exchange, both the memory controller and the memory module would have a shared key that can be used for memory bus protection. At every boot, this key would be different.

Static Key Configuration at Manufacturing/System Integration

In some embodiments, e.g., in closed systems where the memory controller and memory module are manufactured or at least assembled by the same vendor, the shared key may be pre-programmed earlier in the life cycle in the two components to avoid the hardware and/or firmware changes in the components as well as any changes in the memory bus protocols for the key exchange described above. However, in certain instances, complications may arise in the process as the memory controller is owned by the CPU/SoC manufacturer and the memory modules by the memory manufacturer, which are typically two separate entities.

In some embodiments, a common system integrator may take both CPU and memory modules from the respective manufacturers to build systems, and for these units, may use cryptographic and/or secure regulatory protocols. Keys may thus be shared between the CPU and memory module owner entities and could be provisioned securely in the respective component fuses at manufacturing time. In other embodiments, the system integrator may remove burden from the CPU and memory module manufacturers to avoid putting restrictions on the supply chain, and, through special debug hooks/permissions, the system integrator could program the shared key on the components at or near the time of system integration (i.e., when the CPU and memory module are integrated within a larger system). This would remain over the entire life cycle of the respective components.

DDR Bus Encryption

Using the key provisioned in the SoC 110 and the memory module 120, all transactions over the memory bus link 130 are encrypted via the link encryption engine 116. Further data encryption may be provided by the memory encryption engine 114 for data stored in the banks 124 of the memory module 120. For instance, a block cipher-based encryption scheme (e.g., MKTME) may provide encryption of data to be stored in the memory banks 124 of the memory module 120 and the memory bus link encryption would be on top of the encrypted data generated by the block cipher-based encryption scheme.

In certain embodiments, the link encryption engine 116 may implement an encryption scheme/mode that offers temporal uniqueness to the underlying ciphertext generated by the memory encryption engine 114. That is, even when the same data is written at the same address but at a different time, it will encrypt differently in each instance. To this end, the link encryption engine 116 may utilize AES in counter mode (AES-CTR) in certain embodiments.

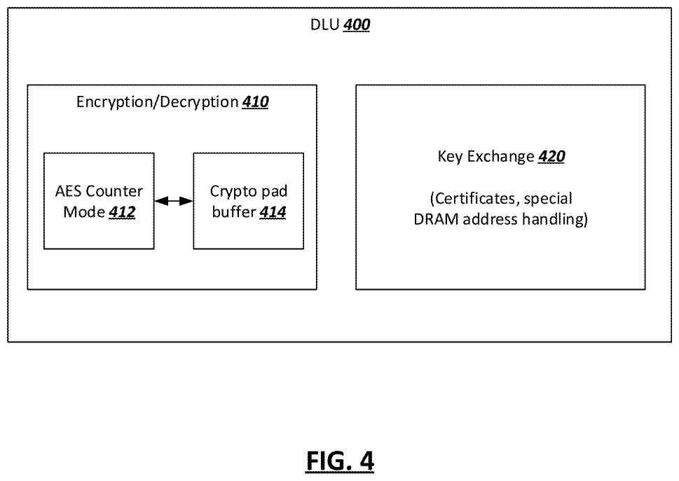

In counter mode encryption, data is encrypted or decrypted using a cryptographic pad value (e.g., a value maintained in a crypto pad buffer 414 of FIG. 4, described further below). Input data (e.g., plaintext) is XORed (exclusive-OR) with a per-transfer unique cryptographic pad value to encrypt or decrypt the input data. The cryptographic pad value may be generated by encrypting a unique seed value, which is temporally unique based on an encryption key (e.g., the one exchanged at boot between the memory controller circuitry and memory module as described above). For temporal uniqueness, a monotonic counter may be used to provide the seed value for the cryptographic pad value. The counter may be incremented for each transfer/transaction to memory over the memory bus link 130. Hence, the counter acts as a version for the data, providing the temporal uniqueness. In particular embodiments, the SoC 110 and the memory module 120 (e.g., the DLU 122) will each maintain two sets of counters, one for the transmit side and one for the receive side. Initial values for each counter may be exchanged at boot so that each of the SoC 110 and memory module 120 maintains the same counter value on each of the counters.

To illustrate the counter concept, the following example may be considered. In the event where an attacker with physical access to a machine is trying to conduct replay attacks, the attack would proceed by recording the data over the bus at time instant t0 and replaying it at a later time t1. The data recorded at t0 would be encrypted with a first version of the data to be replayed. At time t0, this data would be generated using a counter value of c0. At a later point in time, when the attacker intends to inject stale data, the interposer would inject a previously recorded value over the memory bus. However, the counter value used to decrypt this data would now be different as the counters used for encrypting the link are self-incrementing and increment with each transaction sent over the bus. Using a wrong counter to decrypt the injected data would corrupt the underlying ciphertext originally generated by the memory encryption engine 114, thereby defeating the replay attack. In embodiments where integrity is provided by the memory encryption engine 114, and integrity is associated with a KeyID, the MAC verification would also fail, detecting the attack.

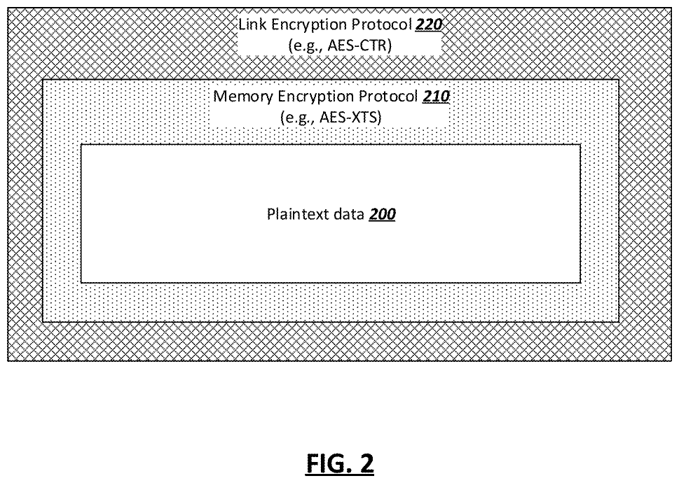

FIG. 2 illustrates example layers of encryption that may be in place in the example system 100 of FIG. 1. As shown, there is underlying plaintext data 200 that is to be transferred over the memory bus link between a chip (e.g., SoC 110) and memory module (e.g., 120). The plaintext data 200 may be, for example, data output by a processor (e.g., 112) that is to be stored in memory. The plaintext data 200 is encrypted via a memory encryption protocol 210 to yield first ciphertext. The first ciphertext generated according to the memory encryption protocol 210 may be the data format that is eventually stored in the memory module. The memory encryption protocol 210 may be an AES-based protocol, such as, for example, AES-XTS. The first ciphertext may be generated by a data encryption engine (e.g., 114) of a memory controller, in certain embodiments.

The first ciphertext generated by the memory encryption protocol 210 is then further encrypted using the link encryption protocol 220 (as a second layer of encryption) for transmission over the memory bus (e.g., 130) to generate second ciphertext. The link encryption protocol 220 may be an AES-based protocol, such as, for example AES-CTR mode. The “doubly encrypted” data or second ciphertext may be of the same size as the plaintext data 200, requiring no additional data to be transmitted over the memory bus as compared with current systems.

Once received at the memory module, the memory module (e.g., using a DLU such as DLU 122) may decrypt the second ciphertext generated by the link encryption protocol 220 to yield the first ciphertext as generated by the memory encryption protocol 210. The first ciphertext may then be stored in the banks of the memory module, to maintain encryption at rest for the underlying plaintext data 200.

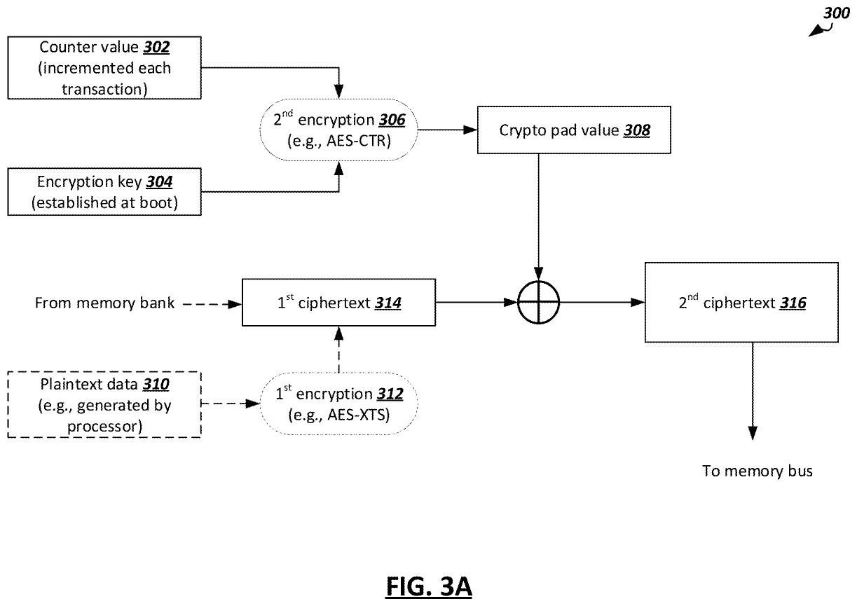

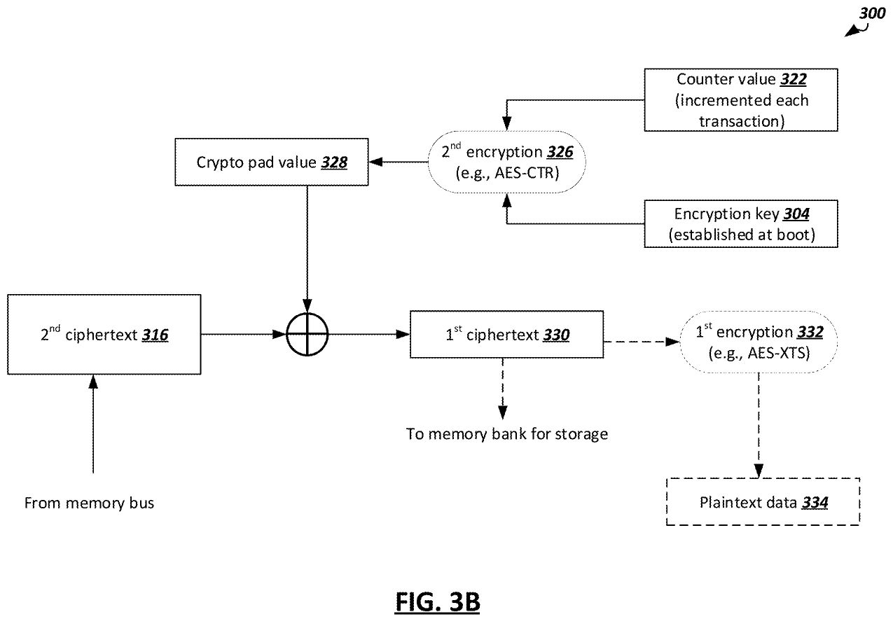

FIGS. 3A-3B illustrate an example encryption/decryption scheme 300 that may be used to implement memory bus encryption in accordance with embodiments of the present disclosure. The example encryption scheme 300 may be implemented by a host SoC (e.g., SoC 110 of FIG. 1) to encrypt data to be transmitted over a memory bus.

Referring first to FIG. 3A, in some instances, e.g., where data is being output by a processor for storage in memory, plaintext data (e.g., generated by the processor) is encrypted using a first encryption protocol 312 to generate first ciphertext 314. The first ciphertext 314 may be the data format that is intended to be stored in memory. In some instances, the first ciphertext 314 may be generated already, e.g., where the first ciphertext 314 is stored in memory and accessed by a DLU.

The first ciphertext 314 may be further encrypted before being sent over the memory bus by performing an XOR operation on the first ciphertext 314 and a cryptographic pad value 308. The cryptographic pad value 308 in the example shown is generated by encrypting a counter value 302 with an encryption key 304 using a second encryption protocol 306. As shown and described above, the counter value 302 may be incremented after each transaction sent over the memory bus to maintain temporal uniqueness. The encryption key 304 may be the encryption key established at boot, as described above. The first encryption protocol may be the AES-XTS protocol, e.g., as used in MKTME, and the second encryption protocol may be the AES-CTR mode protocol.

Referring now to FIG. 3B, decryption may be performed by performing the opposite of the example encryption scheme 300. That is, the second ciphertext 316 may be received and decrypted by XORing the second ciphertext 316 with a cryptographic pad value 328. The cryptographic pad value 328 used on the receive side may be the same as the cryptographic pad value 308 used on the transmit side due to a counter value initialization that is performed at or near boot, before data is transmitted over the memory bus. Thus, the receive side may maintain the same counter value 322 as counter value 302 and may use the same encryption key as encryption key 304 (since they key is a symmetric key established at boot) to produce the cryptographic pad value 328 as 308 using the same encryption protocol 326 as encryption protocol 306.

In some instances, e.g., where the receive side is the memory module, the ciphertext 330 generated by the decryption process on the receive side (which is the same as first ciphertext 314) may be stored in memory. In other instances, e.g., where the receive side is a host SoC/processor, the ciphertext 330 may be further decrypted using another encryption protocol 332 (same as protocol 312) to produce plaintext data 334 (which will be the same as plaintext data 310).

Since the ciphertext is stored on the memory side, and plaintext data is thus not obtained, the memory side may perform the same operations as shown in FIG. 3 to encrypt the ciphertext before transmitted back to the host SoC, with the exception of the 1^{st} encryption performed on the plaintext data (since such plaintext data is not stored on the memory side).

FIG. 4 illustrates an example DLU 400 in accordance with embodiments of the present disclosure. The example DLU 400 may be implemented in a system similar to system 100 of FIG. 1 (e.g., as DLU 122 of FIG. 1). The example DLU 400 includes an encryption/decryption engine 410 and a key exchange engine 420. The encryption/decryption engine 410 includes an AES counter mode (AES-CTR) engine 412 and a crypto pad buffer 414.

The encryption/decryption engine 410 includes circuitry to perform encryption and decryption operations to provide link encryption over a memory bus, e.g., on top of data already encrypted where the data is to be stored in memory in the encrypted state. As described above, in counter mode encryption/decryption, input data may be encrypted or decrypted by XORing the input data with a cryptographic pad value. Thus, the DLU 400 may encrypt/decrypt data using the AES-CTR engine 412 by XORing input data with a cryptographic pad value maintained in the crypto pad buffer 414. The crypto pad buffer 414 may maintain the two counters described above, i.e., a first counter for the transmit side and a second counter for the receive side, and the counters may provide the seed value for generating the cryptographic pad values used in the encryption/decryption process. In some instances, the cryptographic pad values may be pre-generated for the two counters described above.

For example, data being received by the DLU 400 (e.g., via a memory write) from the memory bus may be doubly encrypted, as described above. The doubly encrypted data may be provided to the AES-CTR engine 412 as input, and the AES-CTR engine 412 may decrypt the doubly encrypted data by XORing the doubly encrypted data with a cryptographic pad value maintained in the crypto pad buffer 414. The cryptographic pad value may be based on a counter value associated with data received by the DLU (a “receive-side counter”). For each data transaction received over the memory bus link, the receive-side counter may be incremented, e.g., as described above, providing temporal uniqueness to the link encryption scheme.

For data being transmitted by the DLU 400 over the memory bus (e.g., via a memory read), the data may be stored in the memory in an encrypted manner (e.g., as the first ciphertext described above). The encrypted data stored in memory may be provided to the AES-CTR engine 412 as input, and the AES-CTR engine 412 may further encrypt the encrypted data by XORing the encrypted data with a cryptographic pad value maintained in the crypto pad buffer 414, generating doubly encrypted data for transmission over the memory bus. The cryptographic pad value may be based on a counter value associated with data transmitted by the DLU (a “transmit-side counter”). For each data transaction transmitted over the memory bus link, the transmit-side counter may be incremented, e.g., as described above, providing temporal uniqueness to the link encryption scheme.

The key exchange engine 420 includes circuitry to perform authentication and key exchange with a link encryption engine (e.g., 116). The authentication and key exchange may establish an authenticity of the memory module in which the DLU 400 resides and can establish a key to be used by the encryption/decryption engine 410 to generate the cryptographic pad values stored in the crypto pad buffer 414. The key exchange engine 420, for instance, may maintain certificates or generate digital signatures to be used in the authentication process that is performed between a host processor/SoC and the memory module. The key exchange engine 420 may interface with particular memory addresses in the memory module that are reserved for exchanging authentication and key exchange messages.

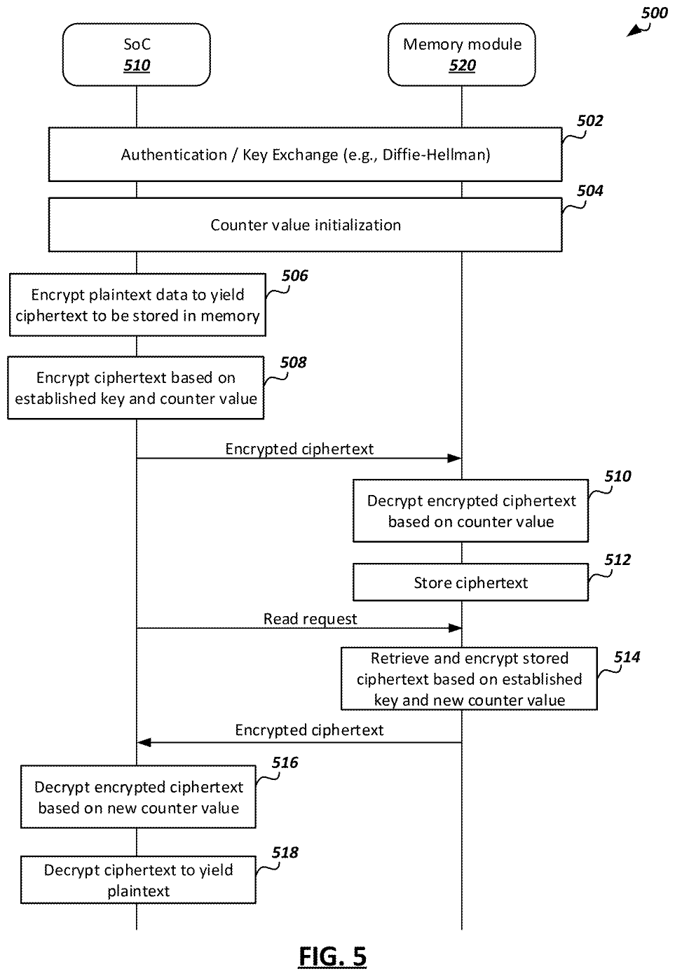

FIG. 5 illustrates a flow diagram of an example process 500 of encrypting data over a memory bus in accordance with embodiments of the present disclosure. The example process 500 may be implemented in software, firmware, hardware, or a combination thereof. For example, the operations shown in FIG. 5 may be implemented in one or more components of an SoC 510 (e.g., memory controller 113 of SoC 110 of FIG. 1) and one or more components of a memory module 520 (e.g., DLU 122 of memory module 120 of FIG. 1). In some embodiments, one or more computer-readable media may be encoded with instructions that implement one or more of the operations in the example process below when executed by a machine (e.g., firmware within a component of the SoC or memory module). The example process may include additional or different operations, and the operations may be performed in the order shown or in another order. In some cases, one or more of the operations shown in FIG. 5 are implemented as processes that include multiple operations, sub-processes, or other types of routines. In some cases, operations can be combined, performed in another order, performed in parallel, iterated, or otherwise repeated or performed another manner.

At 502, the SoC 510 and memory module 520 perform authentication and key exchange operations. A shared encryption key (e.g., symmetric key) may be generated by the key exchange operations performed at 502. In some instances, for example, an authenticated Diffie-Hellman key exchange process may be used.

At 504, counter values may be initialized on each side. The initialized counter values may include two counter values, one for each direction over memory bus (i.e., one for SoC to memory module transactions, and another for memory module to SoC transactions).

At 506, plaintext data is encrypted to yield ciphertext. The plaintext data may be data generated by a processor/core of the SoC 510. In some instances, the ciphertext may be the chosen format in which the data output by the processor of the SoC 510 is to be stored in the memory module 520. The encryption performed at 506 may be based on a block cipher, such as, for example, the AES-XTS mode. At 508, the ciphertext is further encrypted using the key established at 502 and a counter value based on the counter value initialization performed at 504. The counter value may be incremented after each use. The encryption performed at 508 may be based on a block cipher, such as, for example, the AES-CTR mode. In certain embodiments, the operations of 506, 508 may include those shown in FIG. 3. The encrypted ciphertext is then transmitted over the memory bus to the memory module 520.

At 510, the memory module 520 decrypts the encrypted ciphertext based on the same counter value used by the SoC 510 (since they are initialized and then each incremented after each transaction). The protocol used to decrypt the encrypted ciphertext is the same as the encryption protocol used at 508. The ciphertext produced by the decryption at 510 is then stored in the memory module at 512.

Some time later, a read request is received at the memory module 520 from the SoC 510, and at 514, the ciphertext that was stored at 512 is retrieved and encrypted based on the key established at 502 and a new counter value (different from the one used at 508, 510 since the counter values are incremented after each use). The encrypted ciphertext is then transmitted back to the SoC 510 over the memory bus. The SoC 510 decrypts the encrypted ciphertext based on the new counter value at 516 to yield the ciphertext (using the same encryption protocol used at 508), and then decrypts the ciphertext to yield the plaintext data that was used at 506 (using the same encryption protocol used at 506).

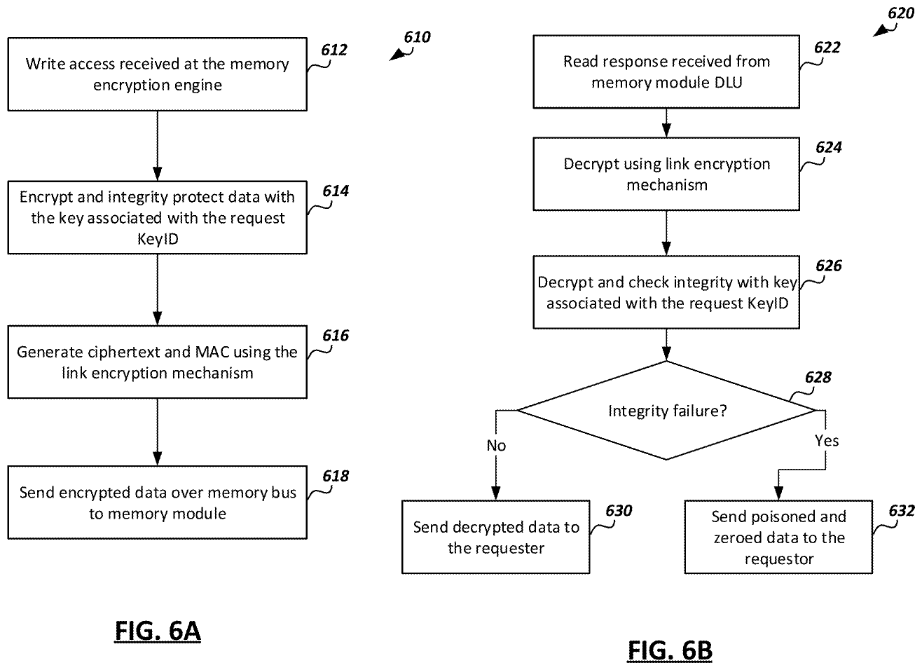

FIGS. 6A-6B illustrate example processes 610, 620 that may be implemented by components of an SoC to provide memory bus encryption in accordance with embodiments of the present disclosure. In particular, FIG. 6A illustrates example write process operations, and FIG. 6B illustrates example read process operations.

At 612, a write access is received at the memory encryption engine (e.g., 114) to write data to a memory module. At 614, the memory encryption engine encrypts the write data with the key associated with the KeyID. The memory encryption engine also generates a message authentication code (MAC) based on the (first) ciphertext, e.g., where the KeyID is programmed with integrity. The ciphertext may be generated at 614 using a block encryption mechanism such as AES-XTS, and the MAC may be generated using a MAC algorithm such as, for example, SHA-3 based KMAC. The ciphertext and MAC are then sent to the link encryption engine.

At 616, the link encryption engine (e.g., 116) generates second ciphertext based on the first ciphertext generated at 614, and encrypts the MAC generated at 614 as well. As an example, the link encryption engine may use a current cryptographic pad value to generate AES-CTR encrypted second ciphertext over the write data received (which is already encrypted as the first ciphertext with AES-XTS). In some embodiments, the link encryption logic can pre-generate cryptographic pad values to minimize any penalty of encryption. The pre-generated cryptographic pad values can be stored in a buffer (e.g., 414 of FIG. 4), which may be deep enough to ensure that there are no bubbles even for b2b requests.

At 618, the second ciphertext is then sent to the memory module over the memory bus. Note that embodiments herein may work irrespective of whether the MAC is stored in error correction code (ECC) devices or in sequestered memory. In embodiments where the MAC is stored in ECC devices, the entire transfer including the data and associated ECC may be sent over the memory bus link as part of a single transaction. In embodiments where the MAC is stored in sequestered memory, the MAC may be sent as separate transaction to the memory module. For the point of view of the link encryption logic, data and MAC may be indistinguishable and may be encrypted transparently.

To prevent rowhammer attacks and provide cryptographic integrity within existing ECC memory modules, block ciphers can be made to match the per-device transaction size (block size=device size). In this mode, a Reed-Solomon (RS) code providing 100% single data device correction (SDDC) (e.g., via a dual ECC device DIMM) can be made into a message authentication code with replay protections provided by the outer encrypted channel to the memory module. Each device contribution to a memory transaction can be encrypted by a block cipher of the same size (e.g., K-cipher or PRINCE for 64 bit devices, or AES for 128 bit devices) and each RS code in the ECC devices can be likewise encrypted with the same size block cipher (RS code is over the data devices before block cipher encryption). The result may be that even single bit corruptions will cascade through the block cipher corrupting the full device. However, the RS code can correct one full block (e.g., device) failure. More extensive corruption will then be detected as an integrity failure and as an uncorrectable error.

At 622, a read response is received at the SoC from a memory module DLU (e.g., DLU 122 of FIG. 1). The read response may include doubly encrypted data as described above. At 624, the doubly encrypted data received in the read response is first decrypted with the link encryption engine (e.g., using AES-CTR) and then sent to the memory encryption engine for further decryption/processing. At 626, the memory encryption engine decrypts and checks for integrity (e.g., where the KeyID associated with the read request has been programmed with integrity) the data received from the link encryption engine.

At 628, the link encryption engine determines whether there has been an integrity failure. If there is no integrity failure (or if integrity was not enabled for the KeyID), the further decrypted data is sent to the requester entity of the SoC at 630. If, however, integrity was enabled and there is an integrity failure, poisoned and zeroed data is returned to the requester at 632.

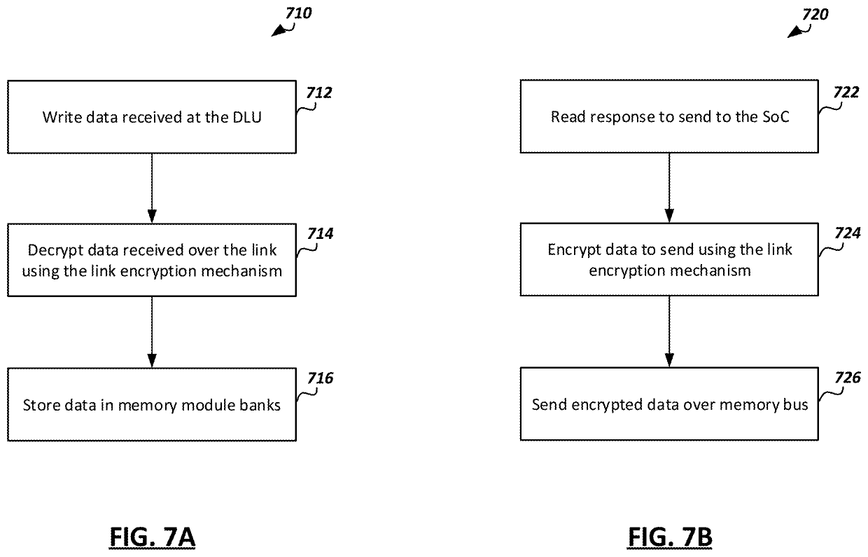

FIGS. 7A-7B illustrate example processes 710, 720 that may be implemented by components of a memory module (e.g., DLU) to provide memory bus encryption in accordance with embodiments of the present disclosure. In particular, FIG. 7A illustrates example write process operations, and FIG. 7B illustrates example read process operations.

At 712, the memory module DLU receives write data from a host SoC or processor. The write data may be doubly encrypted as described above. At 714, the DLU decrypts the data received using the link encryption mechanism (e.g., AES-CTR), and at 716, the DLU causes the decrypted data (which is still encrypted by another mechanism, e.g., AES-XTS) to be stored in the memory banks of the memory module.

At 722, the memory module DLU receives read response data to send back to the host SoC. The read response data may be already encrypted by a memory encryption mechanism (e.g., AES-XTS) and stored in the encrypted state in the memory module. At 724, the memory module DLU encrypts the read response data using the link encryption mechanism (e.g., AES-CTR), and at 726, the DLU causes the doubly encrypted data to be transmitted to the host SoC over the memory bus.

The example processes of FIGS. 6A-6B and 7A-7B may be implemented in software, firmware, hardware, or a combination thereof. For example, the operations shown in these figures may be implemented in one or more components of an SoC (e.g., memory controller 113 of SoC 110 of FIG. 1) and one or more components of a memory module (e.g., DLU 122 of memory module 120 of FIG. 1), respectively. In some embodiments, one or more computer-readable media may be encoded with instructions that implement one or more of the operations in the example process below when executed by a machine (e.g., firmware within a component of the SoC or memory module). The example process may include additional or different operations, and the operations may be performed in the order shown or in another order. In some cases, one or more of the operations shown in FIGS. 6A-6B and 7A-7B are implemented as processes that include multiple operations, sub-processes, or other types of routines. In some cases, operations can be combined, performed in another order, performed in parallel, iterated, or otherwise repeated or performed another manner.

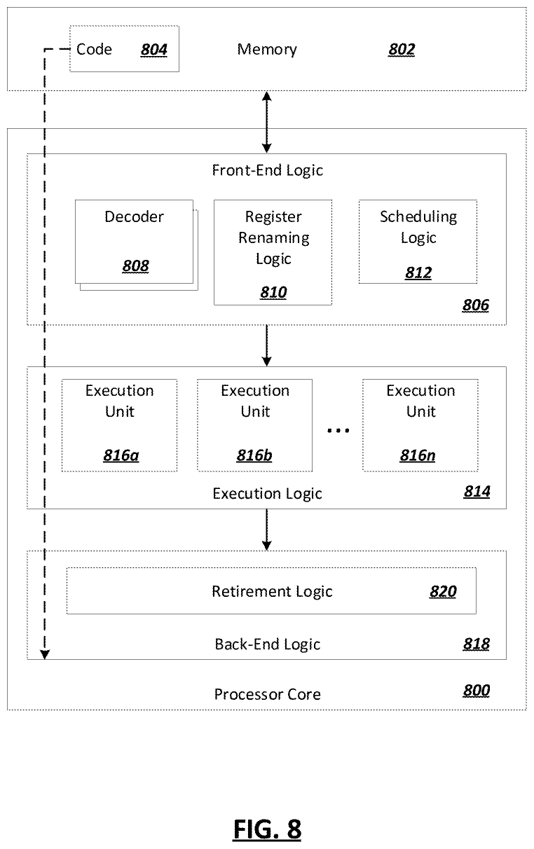

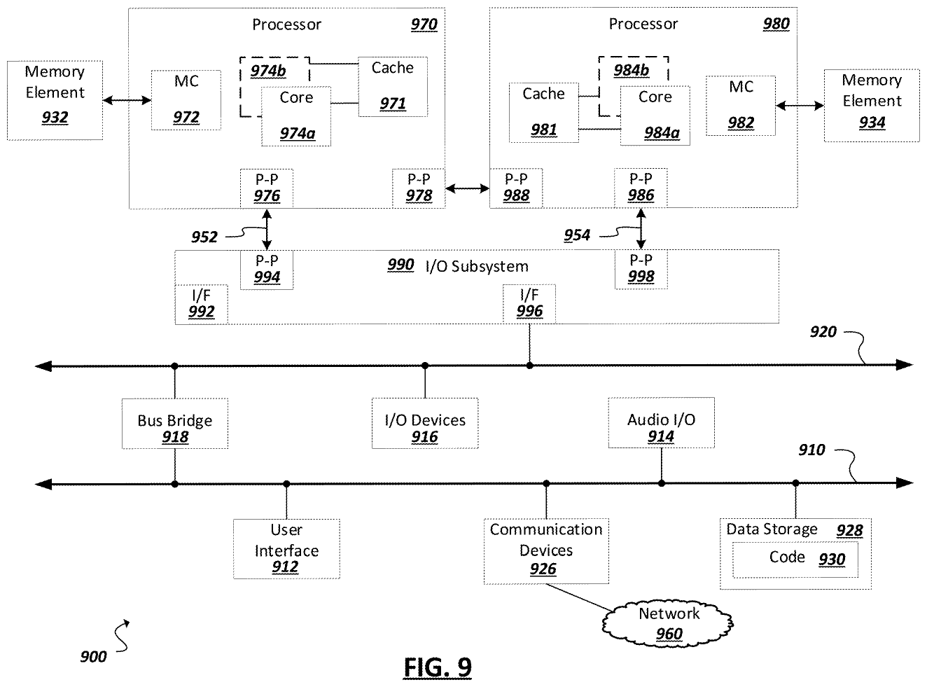

FIGS. 8-9 are block diagrams of example computer architectures that may be used in accordance with embodiments disclosed herein. For example, in some embodiments, a computer system may contain one or more aspects shown in FIGS. 8-9 and may implement one or more aspects of the present disclosure. Other computer architecture designs known in the art for processors and computing systems may also be used. Generally, suitable computer architectures for embodiments disclosed herein can include, but are not limited to, configurations illustrated in FIGS. 8-9.

FIG. 8 is an example illustration of a processor according to an embodiment. Processor 800 is an example of a type of hardware device that can be used in connection with the implementations above. Processor 800 may be any type of processor, such as a microprocessor, an embedded processor, a digital signal processor (DSP), a network processor, a multi-core processor, a single core processor, or other device to execute code. Although only one processor 800 is illustrated in FIG. 8, a processing element may alternatively include more than one of processor 800 illustrated in FIG. 8. Processor 800 may be a single-threaded core or, for at least one embodiment, the processor 800 may be multi-threaded in that it may include more than one hardware thread context (or “logical processor”) per core.

FIG. 8 also illustrates a memory 802 coupled to processor 800 in accordance with an embodiment. Memory 802 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 800 can execute any type of instructions associated with algorithms, processes, or operations detailed herein. Generally, processor 800 can transform an element or an article (e.g., data) from one state or thing to another state or thing.

Code 804, which may be one or more instructions to be executed by processor 800, may be stored in memory 802, or may be stored in software, hardware, firmware, or any suitable combination thereof, or in any other internal or external component, device, element, or object where appropriate and based on particular needs. In one example, processor 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor 800 can also include execution logic 814 having a set of execution units 816a, 816b, 816n, etc. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor 800 allows out of order execution but requires in order retirement of instructions. Retirement logic 820 may take a variety of known forms (e.g., re-order buffers or the like). In this manner, processor 800 is transformed during execution of code 804, at least in terms of the output generated by the decoder, hardware registers and tables utilized by register renaming logic 810, and any registers (not shown) modified by execution logic 814.

Although not shown in FIG. 8, a processing element may include other elements on a chip with processor 800. For example, a processing element may include memory control logic along with processor 800. The processing element may include I/O control logic and/or may include I/O control logic integrated with memory control logic. The processing element may also include one or more caches. In some embodiments, non-volatile memory (such as flash memory or fuses) may also be included on the chip with processor 800.

FIG. 9 illustrates a computing system 900 that is arranged in a point-to-point (PtP) configuration according to an embodiment. In particular, FIG. 9 shows a system where processors, memory, and input/output devices are interconnected by a number of point-to-point interfaces. Generally, one or more of the computing systems described herein may be configured in the same or similar manner as computing system 900.

Processors 970 and 980 may also each include integrated memory controller logic (MC) 972 and 982 to communicate with memory elements 932 and 934. In alternative embodiments, memory controller logic 972 and 982 may be discrete logic separate from processors 970 and 980. Memory elements 932 and/or 934 may store various data to be used by processors 970 and 980 in achieving operations and functionality outlined herein.

Processors 970 and 980 may be any type of processor, such as those discussed in connection with other figures. Processors 970 and 980 may exchange data via a point-to-point (PtP) interface 950 using point-to-point interface circuits 978 and 988, respectively. Processors 970 and 980 may each exchange data with a chipset 990 via individual point-to-point interfaces 952 and 954 using point-to-point interface circuits 976, 986, 994, and 998. Chipset 990 may also exchange data with a co-processor 938, such as a high-performance graphics circuit, machine learning accelerator, or other co-processor 938, via an interface 939, which could be a PtP interface circuit. In alternative embodiments, any or all of the PtP links illustrated in FIG. 9 could be implemented as a multi-drop bus rather than a PtP link.

Chipset 990 may be in communication with a bus 920 via an interface circuit 996. Bus 920 may have one or more devices that communicate over it, such as a bus bridge 918 and I/O devices 916. Via a bus 910, bus bridge 918 may be in communication with other devices such as a user interface 912 (such as a keyboard, mouse, touchscreen, or other input devices), communication devices 926 (such as modems, network interface devices, or other types of communication devices that may communicate through a computer network 960), audio I/O devices 916, and/or a data storage device 928. Data storage device 928 may store code 930, which may be executed by processors 970 and/or 980. In alternative embodiments, any portions of the bus architectures could be implemented with one or more PtP links.

The computer system depicted in FIG. 9 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any embodiments or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. It will be understood that certain examples may be combined with certain other examples, in certain embodiments.

Example A1 includes an apparatus comprising: a memory bus interface to exchange data with a memory module; and circuitry to: perform a key exchange with the memory module at boot to obtain an encryption key; access plaintext data generated by a processor; generate first ciphertext by encrypting the plaintext data using a first encryption protocol; generate second ciphertext by encrypting the first ciphertext using a second encryption protocol based on the encryption key obtained at boot; and cause the second ciphertext to be transmitted to the memory module via the memory bus interface.

Example A2 includes the subject matter of Example A1, wherein the circuitry is to perform the key exchange using an authenticated Diffie-Hellman key exchange protocol.

Example A3 includes the subject matter of any one of Examples A1-A2, wherein the circuitry is further to authenticate the memory module.

Example A4 includes the subject matter of Example A3, wherein the circuitry is to perform the authentication using an authenticated Diffie-Hellman key exchange protocol.

Example A5 includes the subject matter of any one of Examples A1-A4, wherein the circuitry is to maintain a counter value for transactions transmitted via the memory bus interface, and the encryption of the first ciphertext is further based on the counter value.

Example A6 includes the subject matter of Example A5, wherein encrypting the first ciphertext comprises: generating a cryptographic pad value by encrypting the counter value using the encryption key; and performing an exclusive-OR (XOR) operation on the cryptographic value and the first ciphertext.

Example A7 includes the subject matter of Example A5, wherein the circuitry is to increment the counter value after each transaction transmitted via the memory bus interface.

Example A8 includes the subject matter of any one of Examples A1-A7, wherein the circuitry is further to: generate a message authentication code (MAC) based on the first ciphertext; and encrypt the MAC using the second encryption protocol; and cause the encrypted MAC to be transmitted to the memory module via the memory bus interface.

Example A9 includes the subject matter of Example A8, wherein the MAC is generated based on a Reed-Solomon code.

Example A10 includes the subject matter of any one of Examples A1-A9, wherein the circuitry is further to: access data received from the memory module via the memory bus interface; decrypt the received data using the second encryption protocol, wherein the decryption is based on the encryption key; further decrypt the decrypted data using the first encryption protocol to yield plaintext data; and cause the plaintext data to be transmitted to the processor.

Example A11 includes the subject matter of any one of Examples A1-A10, wherein the circuitry is to maintain a counter value for transactions received via the memory bus interface, and the decryption of the data received from the memory module via the memory bus interface is further based on the counter value.

Example A12 includes the subject matter of any one of Examples A1-A11, wherein the first encryption protocol is a block encryption mechanism.

Example A13 includes the subject matter of Example A12, wherein the block encryption mechanism is AES-XTS.

Example A14 includes the subject matter of any one of Examples A1-A13, wherein the second encryption protocol is a block encryption mechanism.

Example A15 includes the subject matter of Example A14, wherein the block encryption mechanism is AES-CTR.

Example C1 includes one or more computer-readable media encoded with instructions that, when executed by one or more processors, cause the one or more processors to: perform a key exchange with a memory module at boot to obtain an encryption key; access plaintext data generated by a processor; generate first ciphertext by encrypting the plaintext data using a first encryption protocol; generate second ciphertext by encrypting the first ciphertext using a second encryption protocol based on the encryption key obtained at boot; and cause the second ciphertext to be transmitted to the memory module via the memory bus interface.

Example C2 includes the subject matter of Example C1, wherein the instructions are to perform the key exchange using an authenticated Diffie-Hellman key exchange protocol.

Example C3 includes the subject matter of any one of Examples C1-C2, wherein the instructions are further to authenticate the memory module.

Example C4 includes the subject matter of Example C3, wherein the instructions are to perform the authentication using an authenticated Diffie-Hellman key exchange protocol.

Example C5 includes the subject matter of any one of Examples C1-C4, wherein the instructions are to maintain a counter value for transactions transmitted via the memory bus interface, and the encryption of the first ciphertext is further based on the counter value.

Example C6 includes the subject matter of Example C5, wherein the instructions are to encrypt the first ciphertext by: generating a cryptographic pad value by encrypting the counter value using the encryption key; and performing an exclusive-OR (XOR) operation on the cryptographic value and the first ciphertext.

Example C7 includes the subject matter of Example C5, wherein the instructions are to increment the counter value after each transaction transmitted via the memory bus interface.

Example C8 includes the subject matter of any one of Examples C1-C7, wherein the instructions are further to: generate a message authentication code (MAC) based on the first ciphertext; and encrypt the MAC using the second encryption protocol; and cause the encrypted MAC to be transmitted to the memory module via the memory bus interface.

Example C9 includes the subject matter of Example C8, wherein the MAC is generated based on a Reed-Solomon code.

Example C10 includes the subject matter of any one of Examples C1-C9, wherein the instructions are further to: access data received from the memory module via the memory bus interface; decrypt the received data using the second encryption protocol, wherein the decryption is based on the encryption key; further decrypt the decrypted data using the first encryption protocol to yield plaintext data; and cause the plaintext data to be transmitted to the processor.

Example C11 includes the subject matter of any one of Examples C1-C10, wherein the instructions are to maintain a counter value for transactions received via the memory bus interface, and the decryption of the data received from the memory module via the memory bus interface is further based on the counter value.

Example C12 includes the subject matter of any one of Examples C1-C11, wherein the first encryption protocol is a block encryption mechanism.

Example C13 includes the subject matter of Example C12, wherein the block encryption mechanism is AES-XTS.

Example C14 includes the subject matter of any one of Examples C1-C13, wherein the second encryption protocol is a block encryption mechanism.

Example C15 includes the subject matter of Example C14, wherein the block encryption mechanism is AES-CTR.

Example M1 includes a method comprising: performing a key exchange with a memory module at boot to obtain an encryption key; access plaintext data generated by a processor; generating first ciphertext by encrypting the plaintext data using a first encryption protocol; generating second ciphertext by encrypting the first ciphertext using a second encryption protocol based on the encryption key obtained at boot; and transmitting the second ciphertext to the memory module via the memory bus interface.

Example M2 includes the subject matter of Example M1, wherein the key exchange is performed using an authenticated Diffie-Hellman key exchange protocol.

Example M3 includes the subject matter of any one of Examples M1-M2, further comprising authenticating the memory module.

Example M4 includes the subject matter of Example M3, further comprising performing the authentication using an authenticated Diffie-Hellman key exchange protocol.

Example M5 includes the subject matter of any one of Examples M1-M4, further comprising maintaining a counter value for transactions transmitted via the memory bus interface, wherein the encryption of the first ciphertext is further based on the counter value.

Example M6 includes the subject matter of Example M5, wherein encrypting the first ciphertext comprises: generating a cryptographic pad value by encrypting the counter value using the encryption key; and performing an exclusive-OR (XOR) operation on the cryptographic value and the first ciphertext.

Example M7 includes the subject matter of Example M5, further comprising incrementing the counter value after each transaction transmitted via the memory bus interface.

Example M8 includes the subject matter of any one of Examples M1-M7, further comprising: generating a message authentication code (MAC) based on the first ciphertext; and encrypting the MAC using the second encryption protocol; and transmitting the encrypted MAC to the memory module via the memory bus interface.

Example M9 includes the subject matter of Example M8, wherein the MAC is generated based on a Reed-Solomon code.

Example M10 includes the subject matter of any one of Examples M1-M9, further comprising: accessing data received from the memory module via the memory bus interface; decrypt the received data using the second encryption protocol, wherein the decryption is based on the encryption key; further decrypting the decrypted data using the first encryption protocol to yield plaintext data; and transmitting the plaintext data to the processor.

Example M11 includes the subject matter of any one of Examples M1-M10, wherein the instructions are to maintain a counter value for transactions received via the memory bus interface, and the decryption of the data received from the memory module via the memory bus interface is further based on the counter value.

Example M12 includes the subject matter of any one of Examples M1-M11, wherein the first encryption protocol is a block encryption mechanism.

Example M13 includes the subject matter of Example M12, wherein the block encryption mechanism is AES-XTS.

Example M14 includes the subject matter of any one of Examples M1-M13, wherein the second encryption protocol is a block encryption mechanism.

Example M15 includes the subject matter of Example M14, wherein the block encryption mechanism is AES-CTR.

Example AA1 includes an apparatus comprising: memory to store data; a memory bus interface to exchange data with a processor; and circuitry to: perform a key exchange with the processor at boot to obtain an encryption key; access data received from the processor over the memory bus interface, wherein the data received from the processor is doubly encrypted; decrypt the doubly encrypted data based on the encryption key obtained at boot to yield ciphertext; and store the ciphertext in the memory.

Example AA2 includes the subject matter of Example AA1, wherein the circuitry is to perform the key exchange using an authenticated Diffie-Hellman key exchange protocol.

Example AA3 includes the subject matter of any one of Examples AA1-AA2, wherein the circuitry is to store the encryption key obtained at boot in a reserved area of the memory.

Example AA4 includes the subject matter of any one of Examples AA1-AA3, wherein the circuitry is to maintain a counter value for transactions received via the memory bus interface, and the decryption of the doubly encrypted data is further based on the counter value.

Example AA5 includes the subject matter of Example AA4, wherein decrypting the doubly encrypted data comprises: generating a cryptographic pad value by encrypting the counter value using the encryption key; and performing an exclusive-OR (XOR) operation on the cryptographic value and the doubly encrypted data.

Example AA6 includes the subject matter of Example AA4, wherein the circuitry is to increment the counter value after each transaction received via the memory bus interface.

Example AA7 includes the subject matter of any one of Examples AA1-AA6, wherein the circuitry is further to: access the stored ciphertext based on a read request received from the processor; encrypt the ciphertext based on the encryption key obtained at boot; and cause the encrypted ciphertext to be transmitted to the processor via the memory bus interface.

Example AA8 includes the subject matter of Example AA7, wherein the circuitry is to maintain a counter value for transactions transmitted via the memory bus interface, and the encryption of the stored ciphertext is further based on the counter value.

Example AA9 includes the subject matter of any one of Examples AA1-AA8, wherein the decryption of the doubly encrypted data is based on a block encryption mechanism.

Example AA10 includes the subject matter of Example AA9, wherein the block encryption mechanism is AES-CTR.

Example CC1 includes one or more computer-readable media encoded with instructions that, when executed by one or more processors, cause the one or more processors to: perform a key exchange with the processor at boot to obtain an encryption key; access data received from the processor over the memory bus interface, wherein the data received from the processor is doubly encrypted; decrypt the doubly encrypted data based on the encryption key obtained at boot to yield ciphertext; and store the ciphertext in the memory.

Example CC2 includes the subject matter of Example CC1, wherein the instructions are to perform the key exchange using an authenticated Diffie-Hellman key exchange protocol.

Example CC3 includes the subject matter of any one of Examples CC1-CC2, wherein the instructions are to store the encryption key obtained at boot in a reserved area of the memory.

Example CC4 includes the subject matter of any one of Examples CC1-CC3, wherein the instructions are to maintain a counter value for transactions received via the memory bus interface, and the decryption of the doubly encrypted data is further based on the counter value.

Example CC5 includes the subject matter of Example CC4, wherein decrypting the doubly encrypted data comprises: generating a cryptographic pad value by encrypting the counter value using the encryption key; and performing an exclusive-OR (XOR) operation on the cryptographic value and the doubly encrypted data.

Example CC6 includes the subject matter of Example CC4, wherein the instructions are to increment the counter value after each transaction received via the memory bus interface.

Example CC7 includes the subject matter of any one of Examples CC1-CC6, wherein the instructions are further to: access the stored ciphertext based on a read request received from the processor; encrypt the ciphertext based on the encryption key obtained at boot; and cause the encrypted ciphertext to be transmitted to the processor via the memory bus interface.

Example CC8 includes the subject matter of Example CC7, wherein the instructions are to maintain a counter value for transactions transmitted via the memory bus interface, and the encryption of the stored ciphertext is further based on the counter value.

Example CC9 includes the subject matter of any one of Examples CC1-CC8, wherein the decryption of the doubly encrypted data is based on a block encryption mechanism.

Example CC10 includes the subject matter of Example CC9, wherein the block encryption mechanism is AES-CTR.

Example MM1 includes a method comprising: performing a key exchange with the processor at boot to obtain an encryption key; accessing data received from the processor over the memory bus interface, wherein the data received from the processor is doubly encrypted; decrypting the doubly encrypted data based on the encryption key obtained at boot to yield ciphertext; and storing the ciphertext in the memory.

Example MM2 includes the subject matter of Example MM1, wherein the key exchange is performed using an authenticated Diffie-Hellman key exchange protocol.

Example MM3 includes the subject matter of any one of Examples MM1-MM2, further comprising storing the encryption key obtained at boot in a reserved area of the memory.

Example MM4 includes the subject matter of any one of Examples MM1-MM3, further comprising maintaining a counter value for transactions received via the memory bus interface, wherein the decryption of the doubly encrypted data is further based on the counter value.

Example MM5 includes the subject matter of Example MM4, wherein decrypting the doubly encrypted data comprises: generating a cryptographic pad value by encrypting the counter value using the encryption key; and performing an exclusive-OR (XOR) operation on the cryptographic value and the doubly encrypted data.

Example MM6 includes the subject matter of Example MM4, further comprising incrementing the counter value after each transaction received via the memory bus interface.

Example MM7 includes the subject matter of any one of Examples MM1-MM6, further comprising: accessing the stored ciphertext based on a read request received from the processor; encrypting the ciphertext based on the encryption key obtained at boot; and transmitting the encrypted ciphertext to the processor via the memory bus interface.

Example MM8 includes the subject matter of Example MM7, further comprising maintaining a counter value for transactions transmitted via the memory bus interface, wherein the encryption of the stored ciphertext is further based on the counter value.

Example MM9 includes the subject matter of any one of Examples MM1-MM8, wherein the decryption of the doubly encrypted data is based on a block encryption mechanism.

Example MM10 includes the subject matter of Example MM9, wherein the block encryption mechanism is AES-CTR.

Example AAA1 includes an apparatus comprising means to implement the method of any one of Examples M1-M15 or MM1-MM10.

Example CCC1 includes machine-readable storage including machine-readable instructions, when executed, to implement a method of any one of Examples M1-M15 or MM1-MM10 or realize an apparatus of any one of Examples A1-A15 or AA1-AA10.

Example S1 includes a system comprising: a processor; and a memory module coupled to the processor over a memory bus; wherein the processor comprises circuitry to: perform a key exchange with the memory module at boot to obtain an encryption key; access plaintext data generated by a processor; generate first ciphertext by encrypting the plaintext data using a first encryption protocol; generate second ciphertext by encrypting the first ciphertext using a second encryption protocol based on the encryption key obtained at boot; and cause the second ciphertext to be transmitted to the memory module via the memory bus interface; and the memory module comprises memory and circuitry to: access the second ciphertext received from the processor over the memory bus; decrypt the second ciphertext based on the encryption key obtained at boot to yield third ciphertext; and store the third ciphertext in the memory.

Example S2 includes the subject matter of Example S1, wherein the processor circuitry is to perform the key exchange using an authenticated Diffie-Hellman key exchange protocol.

Example S3 includes the subject matter of any one of Examples S1-S2, wherein the processor circuitry is further to authenticate the memory module.

Example S4 includes the subject matter of Example S3, wherein the processor circuitry is to perform the authentication using an authenticated Diffie-Hellman key exchange protocol.

Example S5 includes the subject matter of any one of Examples S1-S4, wherein the processor circuitry is to maintain a counter value for transactions transmitted via the memory bus interface, and the encryption of the first ciphertext is further based on the counter value.

Example S6 includes the subject matter of Example S5, wherein encrypting the first ciphertext comprises: generating a cryptographic pad value by encrypting the counter value using the encryption key; and performing an exclusive-OR (XOR) operation on the cryptographic value and the first ciphertext.

Example S7 includes the subject matter of Example S5, wherein the processor circuitry is to increment the counter value after each transaction transmitted via the memory bus interface.

Example S8 includes the subject matter of any one of Examples S1-S7, wherein the processor circuitry is further to: generate a message authentication code (MAC) based on the first ciphertext; and encrypt the MAC using the second encryption protocol; and cause the encrypted MAC to be transmitted to the memory module via the memory bus interface.

Example S9 includes the subject matter of Example S8, wherein the MAC is generated based on a Reed-Solomon code.

Example S10 includes the subject matter of any one of Examples S1-S9, wherein the processor circuitry is further to: access data received from the memory module via the memory bus interface; decrypt the received data using the second encryption protocol, wherein the decryption is based on the encryption key; further decrypt the decrypted data using the first encryption protocol to yield plaintext data; and cause the plaintext data to be transmitted to the processor.

Example S11 includes the subject matter of any one of Examples S1-S10, wherein the processor circuitry is to maintain a counter value for transactions received via the memory bus interface, and the decryption of the data received from the memory module via the memory bus interface is further based on the counter value.

Example S12 includes the subject matter of any one of Examples S1-S11, wherein the first encryption protocol is a block encryption mechanism.

Example S13 includes the subject matter of Example S12, wherein the block encryption mechanism is AES-XTS.

Example S14 includes the subject matter of any one of Examples S1-S13, wherein the second encryption protocol is a block encryption mechanism.

Example S15 includes the subject matter of Example S14, wherein the block encryption mechanism is AES-CTR.

Example S16 includes the subject matter of any one of Examples S1-S15, wherein the memory module circuitry is to store the encryption key obtained at boot in a reserved area of the memory.

Example S17 includes the subject matter of any one of Examples S1-S16, wherein the memory module circuitry is to maintain a counter value for transactions received via the memory bus interface, and the decryption of the doubly encrypted data is further based on the counter value.

Example S18 includes the subject matter of Example S17, wherein decrypting the doubly encrypted data comprises: generating a cryptographic pad value by encrypting the counter value using the encryption key; and performing an exclusive-OR (XOR) operation on the cryptographic value and the doubly encrypted data.

Example S19 includes the subject matter of Example S17, wherein the memory module circuitry is to increment the counter value after each transaction received via the memory bus interface.

Example S20 includes the subject matter of any one of Examples S1-S19, wherein the memory module circuitry is further to: access the stored ciphertext based on a read request received from the processor; encrypt the ciphertext based on the encryption key obtained at boot; and cause the encrypted ciphertext to be transmitted to the processor via the memory bus interface.

Example S21 includes the subject matter of Example S20, wherein the memory module circuitry is to maintain a counter value for transactions transmitted via the memory bus interface, and the encryption of the stored ciphertext is further based on the counter value.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An apparatus comprising:
a memory bus interface to exchange data with a memory module; and
circuitry to:
perform a key exchange with the memory module at boot to obtain an encryption key;
access plaintext data generated by a processor;
generate first ciphertext by encrypting the plaintext data using a first encryption protocol;
generate second ciphertext by encrypting the first ciphertext using a second encryption protocol based on the encryption key obtained at boot; and
cause the second ciphertext to be transmitted to the memory module via the memory bus interface.

2. The apparatus of claim 1, wherein the circuitry is to perform the key exchange using an authenticated Diffie-Hellman key exchange protocol.

3. The apparatus of claim 1, wherein the circuitry is further to authenticate the memory module.

4. The apparatus of claim 3, wherein the circuitry is to perform the authentication using an authenticated Diffie-Hellman key exchange protocol.

5. The apparatus of claim 1, wherein the circuitry is to maintain a counter value for transactions transmitted via the memory bus interface, and the encryption of the first ciphertext is further based on the counter value.

6. The apparatus of claim 5, wherein encrypting the first ciphertext comprises:
generating a cryptographic pad value by encrypting the counter value using the encryption key;
performing an exclusive-OR (XOR) operation on the cryptographic value and the first ciphertext; and
increment the counter value after each transaction transmitted via the memory bus interface.

7. The apparatus of claim 1, wherein the circuitry is further to:
generate a message authentication code (MAC) based on the first ciphertext; and
encrypt the MAC using the second encryption protocol; and
cause the encrypted MAC to be transmitted to the memory module via the memory bus interface.

8. The apparatus of claim 7, wherein the MAC is generated based on a Reed-Solomon code.

9. The apparatus of claim 1, wherein the circuitry is further to:
access data received from the memory module via the memory bus interface;
decrypt the received data using the second encryption protocol, wherein the decryption is based on the encryption key;
further decrypt the decrypted data using the first encryption protocol to yield plaintext data; and
cause the plaintext data to be transmitted to the processor.

10. The apparatus of claim 9, wherein the circuitry is to maintain a counter value for transactions received via the memory bus interface, and the decryption of the data received from the memory module via the memory bus interface is further based on the counter value.

11. One or more computer-readable media encoded with instructions that, when executed by one or more processors, cause the one or more processors to:
perform a key exchange with a memory module at boot to obtain an encryption key;
access plaintext data generated by a processor;
generate first ciphertext by encrypting the plaintext data using a first encryption protocol;
generate second ciphertext by encrypting the first ciphertext using a second encryption protocol based on the encryption key obtained at boot; and
cause the second ciphertext to be transmitted to the memory module via a memory bus interface.

12. The computer-readable media of claim 11, wherein the instructions are to maintain a counter value for transactions transmitted via the memory bus interface, and the encryption of the first ciphertext is further based on the counter value.

13. The computer-readable media of claim 12, wherein the instructions are to encrypt the first ciphertext by:
generating a cryptographic pad value by encrypting the counter value using the encryption key;
performing an exclusive-OR (XOR) operation on the cryptographic value and the first ciphertext; and
incrementing the counter value after each transaction transmitted via the memory bus interface.

14. The computer-readable media of claim 11, wherein the instructions are further to:
generate a message authentication code (MAC) based on the first ciphertext; and
encrypt the MAC using the second encryption protocol; and
cause the encrypted MAC to be transmitted to the memory module via the memory bus interface.

15. The computer-readable media of claim 11, wherein the instructions are further to:
access data received from the memory module via the memory bus interface;
decrypt the received data using the second encryption protocol, wherein the decryption is based on the encryption key;
further decrypt the decrypted data using the first encryption protocol to yield plaintext data; and
cause the plaintext data to be transmitted to the processor.

16. The computer-readable media of claim 15, wherein the instructions are to maintain a counter value for transactions received via the memory bus interface, and the decryption of the data received from the memory module via the memory bus interface is further based on the counter value.

17. A method comprising:
performing a key exchange with a memory module across a memory bus at boot to obtain an encryption key;
obtaining plaintext data generated by a processor;
generating first ciphertext by encrypting the plaintext data using a first encryption protocol;
generating second ciphertext by encrypting the first ciphertext using a second encryption protocol based on the encryption key obtained at boot; and
transmitting the second ciphertext to the memory module via the memory bus.

18. The method of claim 17, further comprising maintaining a counter value for transactions transmitted over the memory bus, and the encryption of the first ciphertext is further based on the counter value.

19. The method of claim 18, wherein encrypting the first ciphertext comprises:
generating a cryptographic pad value by encrypting the counter value using the encryption key;
performing an exclusive-OR (XOR) operation on the cryptographic value and the first ciphertext; and
incrementing the counter value after each transaction transmitted via the memory bus.

20. The method of claim 17, further comprising:
generating a message authentication code (MAC) based on the first ciphertext; and
encrypting the MAC using the second encryption protocol; and
transmitting the encrypted MAC to the memory module via the memory bus.

21. The method of claim 17, further comprising:
obtaining data received from the memory module via the memory bus;
decrypting the received data using the second encryption protocol, wherein the decryption is based on the encryption key;
further decrypting the decrypted data using the first encryption protocol to yield plaintext data; and
transmitting the plaintext data to the processor over the memory bus.

22. The method of claim 21, wherein the instructions are to maintain a counter value for transactions received over the memory bus, and the decryption of the data received from the memory module via the memory bus interface is further based on the counter value.

23. A system comprising:
a processor; and
a memory module coupled to the processor over a memory bus;
wherein the processor comprises circuitry to:
perform a key exchange with the memory module at boot to obtain an encryption key;
access plaintext data generated by a processor;
generate first ciphertext by encrypting the plaintext data using a first encryption protocol;
generate second ciphertext by encrypting the first ciphertext using a second encryption protocol based on the encryption key obtained at boot; and
cause the second ciphertext to be transmitted to the memory module via the memory bus; and
the memory module comprises memory and circuitry to:
access the second ciphertext received from the processor over the memory bus;
decrypt the second ciphertext based on the encryption key obtained at boot to yield third ciphertext; and
store the third ciphertext in the memory.

24. The system of claim 23, wherein the second encryption protocol is based on a block encryption mechanism.

25. The system of claim 24, wherein the block encryption mechanism is Advanced Encryption Standard (AES) in counter mode (AES-CTR).
